(19) United States
(12) Patent Application Publication
(10) Pub. No.: US 2019/0236196 A1
(43) Pub. Date: Aug. 1, 2019

(54) SYSTEM AND METHOD FOR NAVIGATING USING A SEARCH FUNCTIONALITY

(71) Applicant: Nutanix, Inc., San Jose, CA (US)

(72) Inventors: Atreyee Maiti, San Jose, CA (US); Bryan Crowe, San Jose, CA (US); Himanshu Shukla, San Jose, CA (US); Rahul Singh, San Jose, CA (US); Shamita Pisal, San Jose, CA (US); Shyan-Ming Perng, San Jose, CA (US); Ken Chen, San Francisco, CA (US)

(21) Appl. No.: 15/883,818

(22) Filed: Jan. 30, 2018

(51) Int. Cl. G06F 17/30; G06F 9/451; G06F 9/455

(52) U.S. Cl. CPC G06F 17/30572; G06F 17/30569; G06F 9/45533; G06F 9/451; G06F 17/30389

(57) ABSTRACT

A system and method include receiving, by a navigation and search system of a virtual computing system, a user input via a navigation interface of the navigation and search system. The system and method also include retrieving a page corresponding to the user input, parsing the user input and associating one or more keywords with the user input for obtaining a structured query, including associating the page with the structured query, and displaying the page in the navigation interface. The system and method further include populating the structured query into a search interface of the navigation and search system. Either the user input via the navigation interface or the structured query via the search interface are usable to navigate to the page.

### BACKGROUND

The following description is provided to assist the understanding of the reader. None of the information provided or references cited is admitted to be prior art.

Virtual computing systems are widely used in a variety of applications. Virtual computing systems include one or more host machines running one or more virtual machines concurrently. The virtual machines utilize the hardware resources of the underlying host machines. Each virtual machine may be configured to run an instance of an operating system. Modern virtual computing systems allow several operating systems and several software applications to be safely run at the same time on the virtual machines of a single host machine, thereby increasing resource utilization and performance efficiency. However, the present day virtual computing systems have limitations due to their configuration and the way they operate.

### SUMMARY

In accordance with some aspects of the present disclosure, a method is disclosed. The method includes receiving, by a navigation and search system of a virtual computing system, a user input via a navigation interface of the navigation and search system, retrieving, by the navigation and search system, a page corresponding to the user input, and parsing, by the navigation and search system, the user input and associating one or more keywords with the user input for obtaining a structured query, including associating the page with the structured query. The method further includes displaying, by the navigation and search system, the page in the navigation interface, and populating, by the navigation and search system, the structured query into a search interface of the navigation and search system. Either the user input via the navigation interface or the structured query via the search interface are usable to navigate to the page.

In accordance with some other aspects of the present disclosure, a system is disclosed. The system includes a navigation and search system of a virtual computing system including a database configured to store one or more pages associated with the navigation and search system and a processing unit. The processing unit is configured to receive a user input via a navigation interface of the navigation and search system, retrieve one of the one or more pages from the database corresponding to the user input, and parse the user input and associate one or more keywords with the user input for obtaining a structured query, including associating the page with the structured query. The processing unit is further configured to display the one of the one or more pages in the navigation interface and populate the structured query into a search interface of the navigation and search system. Either the user input via the navigation interface or the structured query via the search interface are usable to navigate to the page.

In accordance with yet other aspects of the present disclosure, a non-transitory computer readable media with computer-executable instructions embodied thereon is disclosed, The instructions when executed by a processor of a navigation and search system of a virtual computing system cause the navigation and search system to perform a process. The process includes receiving a user input via a navigation interface of the navigation and search system, retrieving a page corresponding to the user input, and parsing the user input and associating one or more keywords with the user input for obtaining a structured query, including associating the page with the structured query. The process also includes displaying the page in the navigation interface and populating the structured query into a search interface of the navigation and search system. Either the user input via the navigation interface or the structured query via the search interface are usable to navigate to the page.

The foregoing summary is illustrative only and is not intended to be in any way limiting. In addition to the illustrative aspects, embodiments, and features described above, further aspects, embodiments, and features will become apparent by reference to the following drawings and the detailed description.

### BRIEF DESCRIPTION OF THE DRAWINGS

FIG. 1 is an example block diagram of a virtual computing system, in accordance with some embodiments of the present disclosure.

FIG. 2A is another example block diagram of the virtual computing system of FIG. 1 showing a navigation and search system, in accordance with some embodiments of the present disclosure.

FIG. 2B is yet another example block diagram of the virtual computing system of FIG. 1 showing the navigation and search system, in accordance with some embodiments of the present disclosure.

FIG. 3A is an example block diagram showing the navigation and search system of FIGS. 2A and 2B in greater detail, in accordance with some embodiments of the present disclosure.

FIG. 3B is an example screenshot of a portion of the navigation and search system of FIG. 3A, in accordance with some embodiments of the present disclosure.

FIG. 4 is an example flowchart outlining operations for learning how to use a search interface of the navigation and search system for navigating to a particular page in a navigation interface of the navigation and search system, in accordance with some embodiments of the present disclosure.

FIG. 5 is an example flowchart outlining operations for navigating to a particular page in the navigation interface of the navigation and search system using the search interface, in accordance with some embodiments of the present disclosure.

FIG. 6 is an example block diagram of a computing system suitable for implementing an embodiment of the present disclosure.

The foregoing and other features of the present disclosure will become apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and make part of this disclosure.

The present disclosure is generally directed to a virtual computing system having a plurality of clusters, with each cluster having a plurality of nodes. Each of the plurality of nodes includes one or more virtual machines managed by an instance of a hypervisor. These and other various components within the virtual computing system may be part of a data center and may be managed by a user (e.g., an administrator or other authorized personnel). Management of the components may be facilitated via a navigation system having a user interface. Using the user interface, the user may navigate to various pages associated with the components of the data center and manage those components via those pages. Thus, in conventional mechanisms, the user manually navigates through the data center hierarchy using the user interface to monitor the state of each component within the data center.

However, the size and complexity of modern data centers are changing. Typical data centers these days have hundreds or thousands of components to manage. There are more layers of abstraction, such as containers, applications, and workloads. The features that need to be supported are increasing, such as configuring a network, performing upgrades, and deploying a workload, etc. Thus, as the size and complexity of the data centers is increasing, the complexity of the navigation system to manage that data center is also increasing. With increased complexity, time taken to navigate through the navigation system to find and troubleshoot issues impacting the data center, or otherwise manage the components of the data center is also increasing and the effectiveness of the navigation is decreasing. Without proper management through the navigation system, the data center suffers from issues such as network congestion, high latency, inability to meet the capacity requirements of large workloads, and the like. Accordingly, a technical problem currently exists in which there is no mechanism for effectively managing modern data centers and keeping-up with the increasing size and complexity of those data centers.

The present disclosure provides solutions. Specifically, the present disclosure provides a navigation and search system in which the users may navigate using multiple ways. For example, the users may click through various menus, set filters, or interact with other types of user control elements to navigate to a page. Another way that the users may navigate is by using a search feature in which the users may enter search queries to navigate to the same page. Thus, instead of displaying a list of search results, the search feature facilitates direct navigation to desired pages. Thus, the present disclosure integrates navigation and search features.

The navigation and search system of the present disclosure also provides a learnability feature by which the user may learn how to navigate using the search feature. Specifically, the navigation and search system provides a mechanism by which the users may learn to navigate using the search feature while simultaneously navigating using the more familiar form of clicking through menus, setting filters, etc. As discussed below, the navigation and search system converts each user input received from the user via clicking on menus, etc. into a structured query, which is then populated within a search box for the user to see. In a subsequent navigation operation, the user may then simply enter the structured query into the search box and navigate to the same page instead of navigating by clicking through multiple menus and setting filters. By virtue of teaching the users how to navigate using the search feature simultaneously with navigating using more familiar ways, the present disclosure does not require the users to make extra efforts or set aside special learning time to learn how to navigate using the search feature.

Further, as the complexity of the data center increases and the complexity of the navigation system increases, the users may conveniently and easily continue to manage the components of the data center without having to browse or dig through the various navigation menus to find the desired information. Thus, the operation of the navigation system is greatly improved. The user experience and productivity is also improved significantly. Another technical advantage is that the present disclosure provides a mechanism for effectively managing the data center thereby mitigating network congestion, high latency, lack of capacity for deploying large workloads, and the like.

Furthermore, the present disclosure allows the users a choice to navigate. Users that are more comfortable navigating using clicking through menus and settings filters may continue to navigate in that way. Users who are more comfortable navigating via command line prompts may navigate using the search feature.

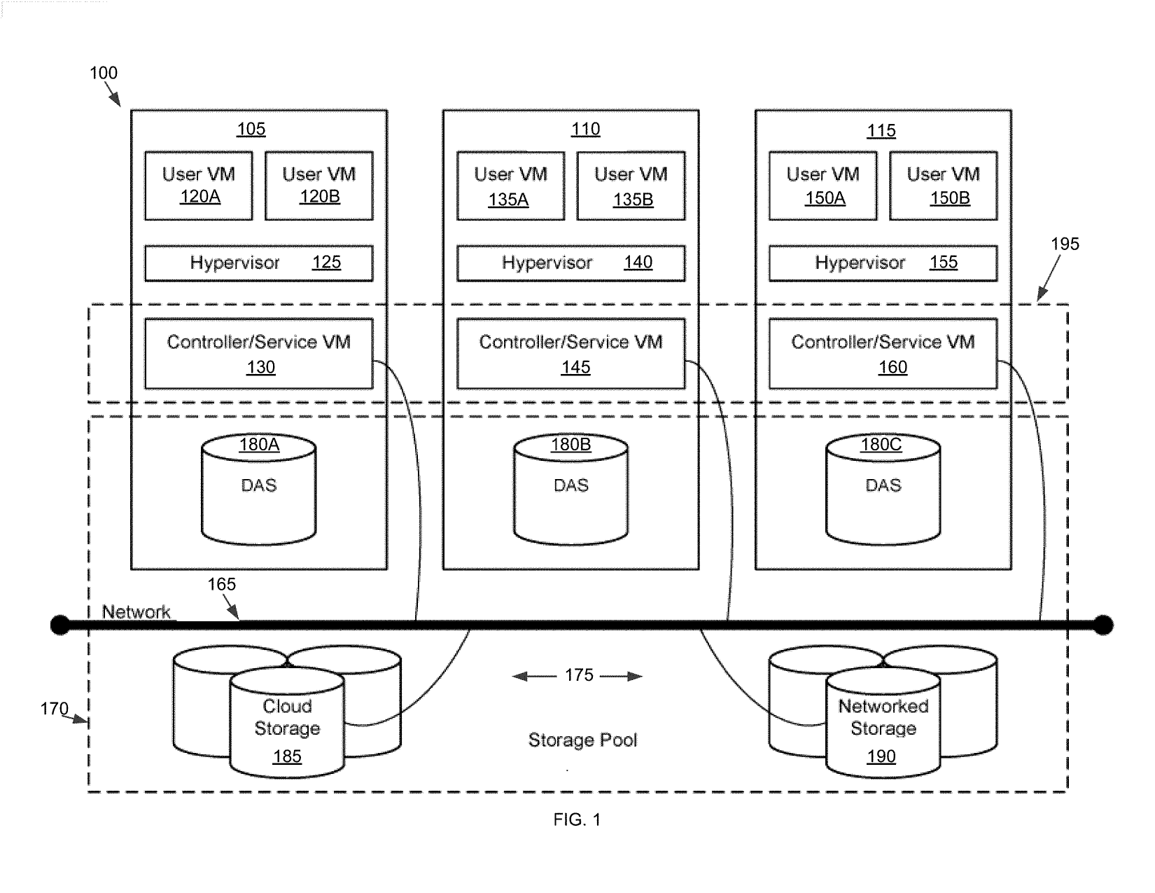

Referring now to FIG. 1, a virtual computing system 100 is shown, in accordance with some embodiments of the present disclosure. The virtual computing system 100 includes a plurality of nodes, such as a first node 105, a second node 110, and a third node 115. Each of the first node 105, the second node 110, and the third node 115 may also be referred to as a “host” or “host machine.” The first node 105 includes user virtual machines (“user VMs”) 120A and 120B (collectively referred to herein as “user VMs 120”), a hypervisor 125 configured to create and run the user VMs, and a controller/service VM 130 configured to manage, route, and otherwise handle workflow requests between the various nodes of the virtual computing system 100. Similarly, the second node 110 includes user VMs 135A and 135B (collectively referred to herein as “user VMs 135”), a hypervisor 140, and a controller/service VM 145, and the third node 115 includes user VMs 150A and 150B (collectively referred to herein as “user VMs 150”), a hypervisor 155, and a controller/service VM 160. The controller/service VM 130, the controller/service VM 145, and the controller/service VM 160 are all connected to a network 165 to facilitate communication between the first node 105, the second node 110, and the third node 115. Although not shown, in some embodiments, the hypervisor 125, the hypervisor 140, and the hypervisor 155 may also be connected to the network 165.

The virtual computing system 100 also includes a storage pool 170. The storage pool 170 may include network-attached storage 175 and direct-attached storage 180A, 180B, and 180C. The network-attached storage 175 is accessible via the network 165 and, in some embodiments, may include cloud storage 185, as well as local storage area network 190. In contrast to the network-attached storage 175, which is accessible via the network 165, the direct-attached storage 180A, 180B, and 180C includes storage components that are provided within each of the first node 105, the second node 110, and the third node 115, respectively, such that each of the first, second, and third nodes may access its respective direct-attached storage without having to access the network 165.

It is to be understood that only certain components of the virtual computing system 100 are shown in FIG. 1. Nevertheless, several other components that are needed or desired in the virtual computing system to perform the functions described herein are contemplated and considered within the scope of the present disclosure. Some additional features of the virtual computing system 100 are described in U.S. Pat. No. 8,601,473, the entirety of which is incorporated by reference herein.

Although three of the plurality of nodes (e.g., the first node 105, the second node 110, and the third node 115) are shown in the virtual computing system 100, in other embodiments, greater than or fewer than three nodes may be used. Likewise, although only two of the user VMs (e.g., the user VMs 120, the user VMs 135, and the user VMs 150) are shown on each of the respective first node 105, the second node 110, and the third node 115, in other embodiments, the number of the user VMs on each of the first, second, and third nodes may vary to include either a single user VM or more than two user VMs. Further, the first node 105, the second node 110, and the third node 115 need not always have the same number of the user VMs (e.g., the user VMs 120, the user VMs 135, and the user VMs 150).

In some embodiments, each of the first node 105, the second node 110, and the third node 115 may be a hardware device, such as a server. For example, in some embodiments, one or more of the first node 105, the second node 110, and the third node 115 may be an NX-1000 server, NX-3000 server, NX-6000 server, NX-8000 server, etc. provided by Nutanix, Inc. or server computers from Dell, Inc., Lenovo Group Ltd. or Lenovo PC International, Cisco Systems, Inc., etc. In other embodiments, one or more of the first node 105, the second node 110, or the third node 115 may be another type of hardware device, such as a personal computer, an input/output or peripheral unit such as a printer, or any type of device that is suitable for use as a node within the virtual computing system 100. In some embodiments, the virtual computing system 100 may be part of a data center.

Each of the first node 105, the second node 110, and the third node 115 may also be configured to communicate and share resources with each other via the network 165. For example, in some embodiments, the first node 105, the second node 110, and the third node 115 may communicate and share resources with each other via the controller/service VM 130, the controller/service VM 145, and the controller/service VM 160, and/or the hypervisor 125, the hypervisor 140, and the hypervisor 155. One or more of the first node 105, the second node 110, and the third node 115 may be organized in a variety of network topologies.

Also, although not shown, one or more of the first node 105, the second node 110, and the third node 115 may include one or more processing units configured to execute instructions. The instructions may be carried out by a special purpose computer, logic circuits, or hardware circuits of the first node 105, the second node 110, and the third node 115. The processing units may be implemented in hardware, firmware, software, or any combination thereof. The term “execution” is, for example, the process of running an application or the carrying out of the operation called for by an instruction. The instructions may be written using one or more programming language, scripting language, assembly language, etc. The processing units, thus, execute an instruction, meaning that they perform the operations called for by that instruction.

The processing units may be operably coupled to the storage pool 170, as well as with other elements of the first node 105, the second node 110, and the third node 115 to receive, send, and process information, and to control the operations of the underlying first, second, or third node. The processing units may retrieve a set of instructions from the storage pool 170, such as, from a permanent memory device like a read only memory (“ROM”) device and copy the instructions in an executable form to a temporary memory device that is generally some form of random access memory (“RAM”). The ROM and RAM may both be part of the storage pool 170, or in some embodiments, may be separately provisioned from the storage pool. Further, the processing units may include a single stand-alone processing unit, or a plurality of processing units that use the same or different processing technology.

With respect to the storage pool 170 and particularly with respect to the direct-attached storage 180A, 180B, and 180C, each of the direct-attached storage may include a variety of types of memory devices. For example, in some embodiments, one or more of the direct-attached storage 180A, 180B, and 180C may include, but is not limited to, any type of RAM, ROM, flash memory, magnetic storage devices (e.g., hard disk, floppy disk, magnetic strips, etc.), optical disks (e.g., compact disk (“CD”), digital versatile disk (“DVD”), etc.), smart cards, solid state devices, etc. Likewise, the network-attached storage 175 may include any of a variety of network accessible storage (e.g., the cloud storage 185, the local storage area network 190, etc.) that is suitable for use within the virtual computing system 100 and accessible via the network 165. The storage pool 170, including the network-attached storage 175 and the direct-attached storage 180A, 180B, and 180C, together form a distributed storage system configured to be accessed by each of the first node 105, the second node 110, and the third node 115 via the network 165, the controller/service VM 130, the controller/service VM 145, the controller/service VM 160, and/or the hypervisor 125, the hypervisor 140, and the hypervisor 155. In some embodiments, the various storage components in the storage pool 170 may be configured as virtual disks for access by the user VMs 120, the user VMs 135, and the user VMs 150.

Each of the user VMs 120, the user VMs 135, and the user VMs 150 is a software-based implementation of a computing machine in the virtual computing system 100. The user VMs 120, the user VMs 135, and the user VMs 150 emulate the functionality of a physical computer. Specifically, the hardware resources, such as processing unit, memory, storage, etc., of the underlying computer (e.g., the first node 105, the second node 110, and the third node 115) are virtualized or transformed by the respective hypervisor 125, the hypervisor 140, and the hypervisor 155, into the underlying support for each of the user VMs 120, the user VMs 135, and the user VMs 150 that may run its own operating system and applications on the underlying physical resources just like a real computer. By encapsulating an entire machine, including CPU, memory, operating system, storage devices, and network devices, the user VMs 120, the user VMs 135, and the user VMs 150 are compatible with most standard operating systems (e.g. Windows, Linux, etc.), applications, and device drivers. Thus, each of the hypervisor 125, the hypervisor 140, and the hypervisor 155 is a virtual machine monitor that allows a single physical server computer (e.g., the first node 105, the second node 110, third node 115) to run multiple instances of the user VMs 120, the user VMs 135, and the user VMs 150, with each user VM sharing the resources of that one physical server computer, potentially across multiple environments. By running the user VMs 120, the user VMs 135, and the user VMs 150 on each of the first node 105, the second node 110, and the third node 115, respectively, multiple workloads and multiple operating systems may be run on a single piece of underlying hardware computer (e.g., the first node, the second node, and the third node) to increase resource utilization and manage workflow.

The user VMs 120, the user VMs 135, and the user VMs 150 are controlled and managed by their respective instance of the controller/service VM 130, the controller/service VM 145, and the controller/service VM 160. The controller/service VM 130, the controller/service VM 145, and the controller/service VM 160 are configured to communicate with each other via the network 165 to form a distributed system 195. Each of the controller/service VM 130, the controller/service VM 145, and the controller/service VM 160 may also include a local management system (e.g., Prism Element from Nutanix, Inc.) configured to manage various tasks and operations within the virtual computing system 100. For example, in some embodiments, the local management system may perform various management related tasks on the user VMs 120, the user VMs 135, and the user VMs 150, as explained in greater detail below.

The hypervisor 125, the hypervisor 140, and the hypervisor 155 of the first node 105, the second node 110, and the third node 115, respectively, may be configured to run virtualization software, such as, ESXi from VMWare, AHV from Nutanix, Inc., XenServer from Citrix Systems, Inc., etc. The virtualization software on the hypervisor 125, the hypervisor 140, and the hypervisor 155 may be configured for running the user VMs 120, the user VMs 135, and the user VMs 150, respectively, and for managing the interactions between those user VMs and the underlying hardware of the first node 105, the second node 110, and the third node 115. Each of the controller/service VM 130, the controller/service VM 145, the controller/service VM 160, the hypervisor 125, the hypervisor 140, and the hypervisor 155 may be configured as suitable for use within the virtual computing system 100.

The network 165 may include any of a variety of wired or wireless network channels that may be suitable for use within the virtual computing system 100. For example, in some embodiments, the network 165 may include wired connections, such as an Ethernet connection, one or more twisted pair wires, coaxial cables, fiber optic cables, etc. In other embodiments, the network 165 may include wireless connections, such as microwaves, infrared waves, radio waves, spread spectrum technologies, satellites, etc. The network 165 may also be configured to communicate with another device using cellular networks, local area networks, wide area networks, the Internet, etc. In some embodiments, the network 165 may include a combination of wired and wireless communications.

Referring still to FIG. 1, in some embodiments, one of the first node 105, the second node 110, or the third node 115 may be configured as a leader node. The leader node may be configured to monitor and handle requests from other nodes in the virtual computing system 100. For example, a particular user VM (e.g., the user VMs 120, the user VMs 135, or the user VMs 150) may direct an input/output request to the controller/service VM (e.g., the controller/service VM 130, the controller/service VM 145, or the controller/service VM 160, respectively) on the underlying node (e.g., the first node 105, the second node 110, or the third node 115, respectively). Upon receiving the input/output request, that controller/service VM may direct the input/output request to the controller/service VM (e.g., one of the controller/service VM 130, the controller/service VM 145, or the controller/service VM 160) of the leader node. In some cases, the controller/service VM that receives the input/output request may itself be on the leader node, in which case, the controller/service VM does not transfer the request, but rather handles the request itself.

The controller/service VM of the leader node may fulfill the input/output request (and/or request another component within the virtual computing system 100 to fulfill that request). Upon fulfilling the input/output request, the controller/service VM of the leader node may send a response back to the controller/service VM of the node from which the request was received, which in turn may pass the response to the user VM that initiated the request. In a similar manner, the leader node may also be configured to receive and handle requests (e.g., user requests) from outside of the virtual computing system 100. If the leader node fails, another leader node may be designated.

Furthermore, one or more of the first node 105, the second node 110, and the third node 115 may be combined together to form a network cluster (also referred to herein as simply “cluster.”) Generally speaking, all of the nodes (e.g., the first node 105, the second node 110, and the third node 115) in the virtual computing system 100 may be divided into one or more clusters. One or more components of the storage pool 170 may be part of the cluster as well. For example, the virtual computing system 100 as shown in FIG. 1 may form one cluster in some embodiments. Multiple clusters may exist within a given virtual computing system (e.g., the virtual computing system 100). The user VMs 120, the user VMs 135, and the user VMs 150 that are part of a cluster are configured to share resources with each other. In some embodiments, multiple clusters may share resources with one another.

Additionally, in some embodiments, although not shown, the virtual computing system 100 includes a central management system (e.g., Prism Central from Nutanix, Inc.) that is configured to manage and control the operation of the various clusters in the virtual computing system. In some embodiments, the central management system may be configured to communicate with the local management systems on each of the controller/service VM 130, the controller/service VM 145, the controller/service VM 160 for controlling the various clusters.

Again, it is to be understood again that only certain components and features of the virtual computing system 100 are shown and described herein. Nevertheless, other components and features that may be needed or desired to perform the functions described herein are contemplated and considered within the scope of the present disclosure. It is also to be understood that the configuration of the various components of the virtual computing system 100 described above is only an example and is not intended to be limiting in any way. Rather, the configuration of those components may vary to perform the functions described herein.

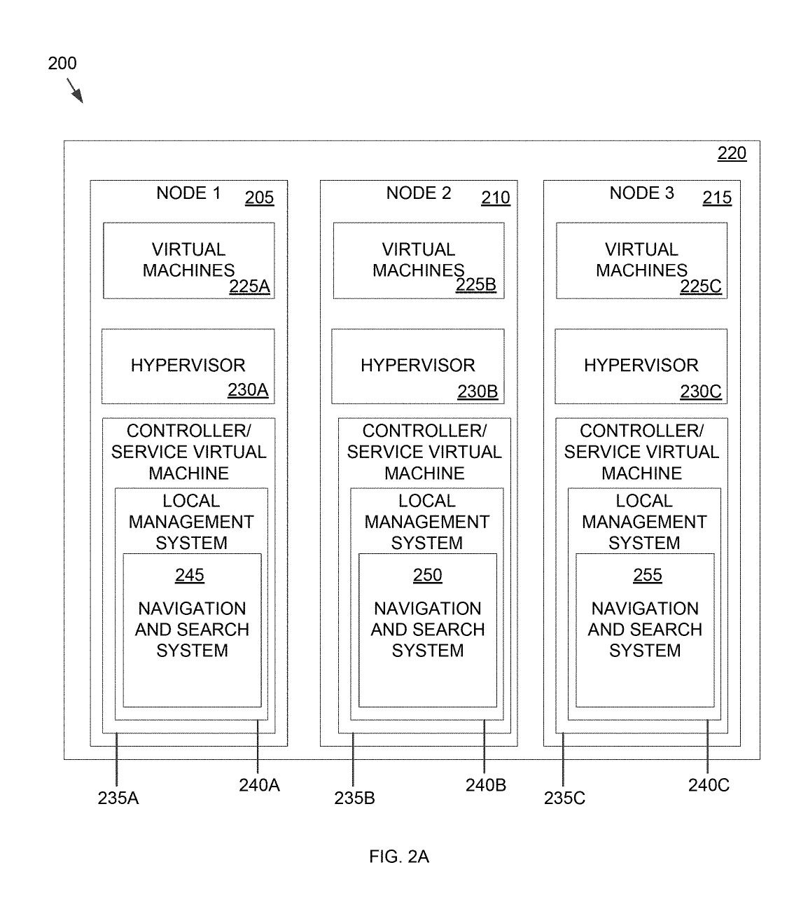

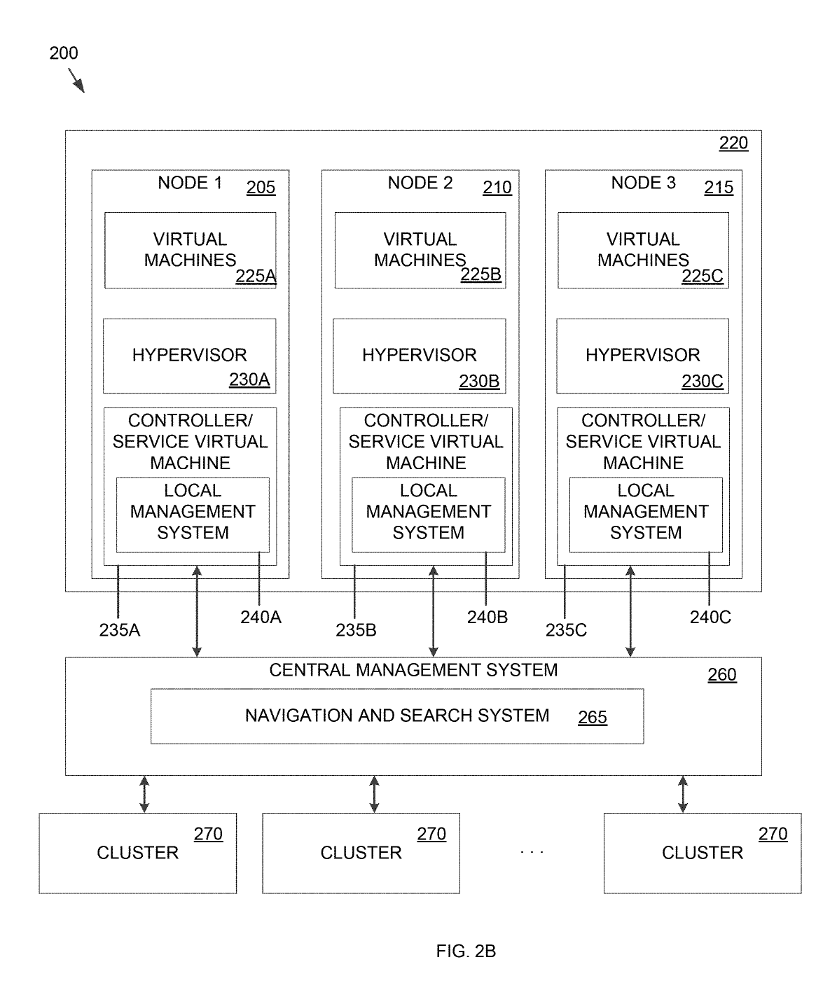

Turning to FIGS. 2A and 2B, another block diagram of a virtual computing system 200 is shown, in accordance with some embodiments of the present disclosure. The virtual computing system 200 is analogous to, albeit a simplified version, of the virtual computing system 100. Thus, although only some of the components have been shown in the virtual computing system 200, the virtual computing system is intended to include other components and features, as discussed above with respect to the virtual computing system 100. Referring to FIGS. 2A and 2B together, the virtual computing system 200 includes a first node 205, a second node 210, and a third node 215, all of which form part of a cluster 220. Although only three nodes (e.g., the first node 205, the second node 210, and the third node 215) have been shown in the cluster 220, the number of nodes may vary to be greater than or fewer than three.

The first node 205 includes virtual machines 225A, the second node 210 includes virtual machines 225B, and the third node 215 includes virtual machines 225C. Additionally, the first node 205 includes a hypervisor 230A and a controller/service virtual machine 235A. Similarly, the second node 210 includes a hypervisor 230B, and a controller/service virtual machine 235B, while the third node 215 includes a hypervisor 230C, and a controller/service virtual machine 235C. Further, each of the controller/service virtual machine 235A, controller/service virtual machine 235B, and controller/service virtual machine 235C respectively include a local management system 240A, a local management system 240B, and a local management system 240C. The local management system 240A, the local management system 240B, and the local management system 240C, in some embodiments, may be the Prism Element component from Nutanix, Inc., and may be configured to perform a variety of management tasks on the underlying node (e.g., the first node 205, the second node 210, and the third node 215, respectively).

Referring now specifically to FIG. 2A, the local management system 240A, the local management system 240B, and the local management system 240C, respectively, include a navigation and search system 245, a navigation and search system 250, and a navigation and search system 255. The navigation and search system 245, the navigation and search system 250, and the navigation and search system 255 are each configured to facilitate management of various components associated with the virtual computing system 200 by providing navigation features. Specifically, the navigation and search system 245, the navigation and search system 250, and the navigation and search system 255 are each configured to provide an integrated navigation interface and search interface using which a user may navigate to desired pages associated with the various components of the virtual computing system 200 to view, modify, or otherwise manage those components from those pages, as explained in greater detail below.

In some embodiments and as shown in FIG. 2B, instead of being part of the local management system 240A, the local management system 240B, and the local management system 240C, the navigation and search system may be part of a central management system (also referred to herein as “overall management system”) 260. Thus, the central management system 260 may include a navigation and search system 265. The central management system 260, in some embodiments, is the Prism Central component from Nutanix, Inc. that is configured to manage all of the clusters (e.g., including the cluster 220 and clusters 270) within the virtual computing system 200.

Further, in some embodiments, the central management system 260 may communicate with the local management system 240A, the local management system 240B, and the local management system 240C of the cluster 220 for managing the various components of that cluster. In other embodiments, the central management system 260 may communicate with the local management system (e.g., the local management system 240A, the local management system 240B, or the local management system 240C) on the leader node or a local management system designated to communicate with the central management system. Similarly, the central management system 260 may communicate with the local management systems of the nodes of the clusters 270 in the virtual computing system 200 for managing those clusters.

The navigation and search system 265 is analogous to each of the navigation and search system 245, the navigation and search system 250, and the navigation and search system 255 of FIG. 2A discussed above. Further, although each of navigation and search system 245, the navigation and search system 250, and the navigation and search system 255 of FIG. 2A is shown as entirely being a part of the local management system 240A, the local management system 240B, and the local management system 240C, respectively, and the navigation and search system 265 of FIG. 2B is shown as entirely being a part of the central management system 260, in some embodiments, portions of those navigation and search systems may be part of the local management system and other portions may be part of the central management system. In other embodiments, an instance of the navigation and search system (e.g., the navigation and search system 245, the navigation and search system 250, and the navigation and search system 255, the navigation and search system 265) may be provided in both, the local management system (e.g., the local management system 240A, the local management system 240B, and the local management system 240C), as well as the central management system (e.g., the central management system 260). Thus, the navigation and search system 245, the navigation and search system 250, the navigation and search system 255, and the navigation and search system 265 may be configured in a variety of ways.

Again, notwithstanding the components of the virtual computing system 200 shown and described herein, in other embodiments, the virtual computing system 200 is intended to include other components and features, as described above with respect to the virtual computing system 100.

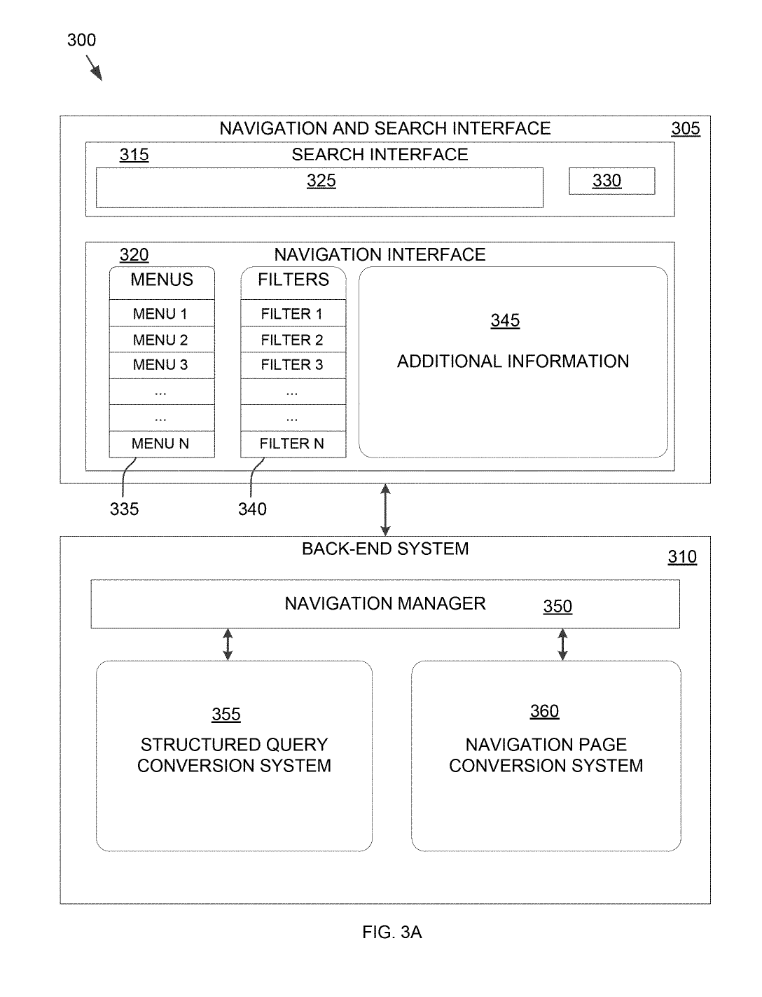

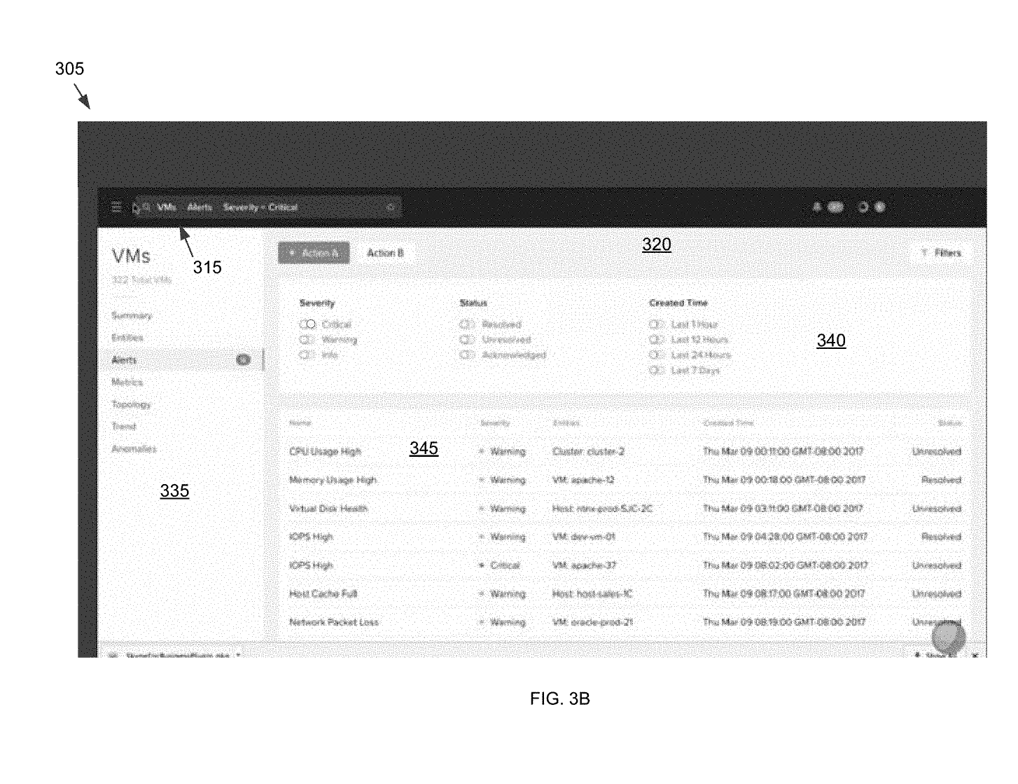

Turning now to FIG. 3A, an example block diagram of a navigation and search system 300 is shown, in accordance with some embodiments of the present disclosure. The navigation and search system 300 is configured to facilitate navigation to pages associated with various components (also referred to herein as “entities”) within the virtual computing system (e.g., the virtual computing system 100). Specifically, the navigation and search system 300 enables a user to navigate to a specific page associated with a particular entity to be managed and perform management operations on that entity via that page. An “entity” as used herein means clusters, nodes, virtual machines, virtual disks, software applications, and other hardware, software, storage, virtual clouds, and data center components that make up a virtual computing system (e.g., the virtual computing system 100 and the virtual computing system 200).

The navigation and search system 300 includes a front-end system, namely, a navigation and search interface 305 that is viewable by the user and is configured to receive inputs from the user (also referred to herein as “user inputs”). The navigation and search interface 305 is also configured to return outputs back to the user in response to the user inputs. The navigation and search system 300 also includes a back-end system 310 that is not visible to the user, but is rather configured to receive the user inputs received via the navigation and search interface 305 and return pages as outputs corresponding to the user inputs for displaying on the navigation and search interface.

In some embodiments, the navigation and search system 300 may be provided via an application programming interface (“API”). In such cases, users may access the navigation and search system 300 via designated devices such as laptops, desktops, tablets, other handheld or portable devices, and/or other types of computing devices that are configured to access the API. The API provides an interface with a set of routines, protocols, and tools to allow users to access the navigation and search system 300. In some embodiments, the API may be a representational state transfer (“REST”) type of API. In other embodiments, the API may be any other type of web or other type of API (e.g., ASP.NET) built using any of a variety of technologies, such as Java, .Net, etc., that is capable of accessing the navigation and search system 300 and facilitating communication between the users and the navigation and search system.

In some embodiments, the API may be configured to facilitate communication between the users and the navigation and search system 300 via a hypertext transfer protocol (“HTTP”) or hypertext transfer protocol secure (“HTTPS”) type request. The API may receive an HTTP/HTTPS request and send an HTTP/HTTPS response back. In other embodiments, the API may be configured to facilitate communication between the users and the navigation and search system 300 using other or additional types of communication protocols. In some embodiments and when the navigation and search system 300 is configured for use via an API, the users may access the navigation and search interface 305 of the navigation and search system via a web browser and upon entering a uniform resource locator (“URL”) for the API. Using the API, the users may then send user inputs to the back-end system 310 and receive outputs from the back-end system.

In other embodiments, the navigation and search system 300 may be configured for user access in other ways. Thus, the mechanism by which the navigation and search system 300 is made available to the users may vary from one embodiment to another.

As indicated above, the navigation and search system 300 includes the navigation and search interface 305. The navigation and search interface 305 is a user interface that facilitates human-computer interaction between the users and the navigation and search system 300. Thus, the navigation and search interface 305 is configured to receive user inputs from the users and transmit those user inputs to the back-end system 310. The navigation and search interface 305 is also configured to receive outputs from the back-end system 310 and present those outputs to the users via the navigation and search interface. In some embodiments, the navigation and search interface 305 is configured as a graphical user interface (“GUI”). The GUI may present a variety of graphical icons, visual indicators, menus, visual widgets, and other indicia to facilitate user interaction. In other embodiments, the navigation and search interface 305 may be configured as other types of user interfaces, including for example, text-based user interfaces, man-machine interfaces, etc. In some embodiments, a portion of the navigation and search interface 305 may be configured as one type of user interface (e.g., GUI), while another portion of the navigation and search interface may be configured as another type of user interface (e.g., text-based). Thus, the navigation and search interface 305 may be configured in a variety of ways.

Further, the navigation and search interface 305 may be configured to receive the user inputs in a variety of ways. For example, the navigation and search interface 305 may be configured to receive the user inputs using input technologies including, but not limited to, a keyboard, a stylus and/or touch screen, a mouse, a track ball, a keypad, a microphone, voice recognition, motion recognition, remote controllers, input ports, one or more buttons, dials, joysticks, etc. that allow an external source, such as the user, to enter information into the navigation and search interface. The navigation and search interface 305 may also be configured to present outputs from the back-end system 310 to the users in a variety of ways. For example, the navigation and search interface 305 may be configured to present information to external systems, users, memory, printers, speakers, etc.

Therefore, although not shown, the navigation and search interface 305 may be associated with a variety of hardware, software, firmware components, or combinations thereof. Generally speaking, the navigation and search interface 305 may be associated with any type of hardware, software, and/or firmware component that enables the navigation and search interface to perform the functions described herein.

Additionally, the navigation and search interface 305 may be configured to present information to the users in one or more “windows.” A “window” as used herein means a graphical control element or widget that provides a frame or visual area for presenting data or features in the form of web pages, messages, graphs, etc. The users may interact with the data or features in the windows to send user inputs and receive outputs. Such interactions may open new windows, replace old windows with new windows, etc. When a new window is opened, that new window may overlap the old window, open as a new tab, etc. Thus, the manner in which information is displayed on the navigation and search interface 305 may vary from one embodiment to another.

Referring now to FIG. 3A in conjunction with FIG. 3B, the navigation and search interface 305 includes a search interface 315 and a navigation interface 320. A screenshot of an example navigation and search interface (e.g., the navigation and search interface 305) showing the search interface 315 and the navigation interface 320 is shown in FIG. 3B. For consistency, same reference numerals are used in both FIGS. 3A and 3B. In some embodiments, the search interface 315 and the navigation interface 320 may be displayed within separate windows that are both visible to the users at the same time or within the same windows in different areas (as shown in FIG. 3B). It is to be understood that the placement and design (e.g., shape, size, font, orientation, etc.) of the search interface 315 and the navigation interface 320 as shown in FIGS. 3A and 3B and described herein are only examples and not intended to be limiting in any way. Rather, the placement and design of the search interface 315, the navigation interface 320, and/or other features of the navigation and search interface 305 may vary from one embodiment to another.

The search interface 315 includes a search box 325 to receive search queries from the users and a search button 330 to send the search queries to the back-end system 310. The search interface 315 is configured to facilitate navigation. Specifically, the search interface 315 may be used to navigate directly to specific pages instead of providing a listing of search results. In some embodiments, the search interface 315 may be used to perform a traditional search as well in which a listing of search results is displayed.

The navigation interface 320 may be configured in a variety of ways to facilitate user interaction and navigation to pages within the navigation and search system 300. For example, in some embodiments and as shown, the navigation interface 320 may include a variety of menus 335, a variety of filters 340, and other types of user control or graphical elements, referred to herein as additional information 345. Data may also be displayed as part of the additional information 345. The menus 335, the filters 340, and the additional information 345 are collectively referred to herein as “elements.” It is to be understood that the configuration of the elements including the placement and design of those elements within the navigation interface 320 may vary from one embodiment to another. Further, although only the menus 335 and the filters 340 have been shown in the navigation interface 320, in other embodiments, additional or other type of information may be presented on the navigation interface that the user may interact with to access pages. For example, in some embodiments, the navigation interface 320 (or the navigation and search interface 305 in general) may include user control elements for site navigation, help resources, and other types of user control elements that are considered desirable or necessary.

Further, the configuration of the menus 335 and the filters 340 may vary from one embodiment to another. For example, in some embodiments, either or both the menus 335 and the filters 340 may be configured as drop-down lists, fly-out items, pop-up items, context items, stand-alone icons, etc. Further, in some embodiments, at least some of the menus 335 may be configured such that interacting with one of the menus 335 may lead to another set of one or more menus, and interaction with one of those one or more menus may lead to yet another set of menus, and so on. Thus, at least some of the menus 335 may be nested within one another. Each of the menus 335 may eventually lead to a particular page within the navigation and search system 300.

Additionally, the type of the menus 335 that are displayed within the navigation interface 320 may vary from one page to another depending upon the type of information that is considered suitable to be presented to the user on (or via) that page. Some example menus that may be provided in the menus 335 may include a settings menu to view and/or modify the settings (e.g., types of menus and filters to show, font types and sizes, etc.) of the navigation and search interface 305 in general, as well as to control the settings of entities, an entities menu configured to access information pertaining to the various entities within the virtual computing system (e.g., the virtual computing system 100), an alerts menu configured to display all alerts being generated by entities, etc. It is to be understood that the type of menus mentioned above are simply examples. In other embodiments, additional and/or other types of menus may be presented on each page and displayed within the navigation interface 320.

Similarly, the filters 340 may include a variety of filters. The type of filters that are made available may vary based upon the entity or attribute for which the filter is being set. For example, filters for alerts may be different than filters for power usage, which in turn may be different from filters for performance or entity names, etc. Thus, depending upon the entity or attribute for which the filters 340 are provided, the type of filters may vary. Some example filters for alerts are shown in FIG. 3B. Each filter may be enabled or disabled by the user. By enabling or disabling filters, the users can decide what type of information to view on a particular page. Thus, the configuration of the filters 340 may also vary from one embodiment to another.

The user may interact with the menus 335 and the filters 340 to access relevant information (e.g., pages) via the navigation interface 320. As used herein, a “page” is a document (e.g., like a web page) containing a variety of relevant information. The information that is displayed on one page may vary from the information that is displayed on another page. Further, the design of each page may vary from other pages. A collection of all such pages make up the navigation and search system 300. The pages may be stored within a database (e.g., the storage pool 170) associated with the back-end system 310. Further, the pages may be written in a hypertext markup language (HTML) using a variety of scripts such as PHP, ASP, Perl, JSP, etc. or another type of programming language/script that the navigation and search system 300 is configured to understand. Each page may be static, dynamic, or a combination of both. Static pages show the same information each time those pages are accessed. The information shown in dynamic pages may change. Further, each page may be configured to provide user control elements (e.g., the menus 335, the filters 340, etc.) that the user may interact with to access additional pages and/or data that is relevant to be displayed on that particular page. An example of what a page may look like is shown in FIG. 3B.

Thus, the navigation and search interface 305, and particularly the search interface 315 and the navigation interface 320, may be configured in a variety of ways. Again, it is to be understood that the various features of the navigation and search interface 305 discussed above are simply examples and not intended to be limiting in any way. The placement, design, configuration, and the various features that are made available to the user via the navigation and search interface 305 may vary from one embodiment to another. Further, only certain features of the navigation and search interface 305 are shown herein. Nevertheless, in other embodiments, other features that are commonly provided on user interfaces and particularly, on user interfaces used in a virtualization environment (e.g., the virtual computing system 100) may be provided. For example, in some embodiments, the navigation and search interface 305 may include other types of navigational menus, adjustment options, adjustment settings, adjustment display settings, etc.

Referring still to FIG. 3, the back-end system 310 is configured to receive the user inputs via the navigation and search interface 305, analyze the user inputs, and present pages on the navigation and search interface in response to those user inputs. The search queries received via the search interface 315 and the inputs received via the navigation interface 320 are collectively referred to herein as the user inputs. When the users interact with (e.g., click on) a particular user control element (e.g., the menus 335, the filters 340, etc.) on the navigation interface 320 or send in a search query via the search interface 315, those user inputs (or indications thereof) are sent via a network (not shown) to the back-end system 310. The back-end system 310 analyzes the user inputs to identify the content that is associated with those inputs, and causes that content to be displayed as a page on the navigation and search interface.

Although not shown, the back-end system 310 may be configured as hardware, software, firmware, or a combination thereof. Specifically, the back-end system 310 may include one or more processing units configured to execute instructions and one or more memory units to store those instructions and other conversion related data. In some embodiments, the back-end system 310 may be connected to a storage pool (e.g., the storage pool 170) to receive, send, and process information, and to control the interactions with the users. The instructions may be carried out by a special purpose computer, logic circuits, or hardware circuits of the back-end system 310. The processing units may, thus, be implemented in hardware, firmware, software, or any combination thereof. The processing units execute an instruction, meaning that they perform the operations called for by that instruction. The processing units may retrieve a set of instructions from a memory (e.g., the storage pool 170 or any other memory in which such instructions may be stored). For example, in some embodiments, the processing units may retrieve the instructions from a permanent memory device like a read only memory (ROM) device and copy the instructions in an executable form to a temporary memory device that is generally some form of random access memory (RAM). The ROM and RAM may both be part of the storage pool (e.g., the storage pool 170), or in some embodiments, may be separately provisioned from the storage pool. Further, the processing units may include a single stand-alone processing unit, or a plurality of processing units that use the same or different processing technology. The instructions may be written using one or more programming language, scripting language, assembly language, etc.

The back-end system 310 includes (or is associated with) a navigation manager 350 that is configured to receive the user inputs from the navigation and search interface 305 and cause pages to be displayed on the navigation and search interface in response to those user inputs. The navigation manager 350 is in communication with a structured query conversion system 355 and a navigation page conversion system 360. Although the structured query conversion system 355 and the navigation page conversion system 360 are shown as separate components, in some embodiments, the structured query conversion system and the navigation page conversion system may be integrated together.

The structured query conversion system 355 is configured to convert each user input received via the navigation interface 320 into a structured query. The structured query conversion system 355 (and/or the navigation manager 350) is also configured to store the structured query within a database (e.g., the storage pool 170) for later use. In some embodiments, the structured query conversion system 355 is further configured to receive structured queries from the search interface 315 and identify pages associated with those structured queries to be displayed within the navigation interface 320. In some cases, the structured query conversion system 355 may be configured to receive search queries via the search interface 315 that are not in a structured query format, convert those search queries in a structured query format, and identify corresponding pages to be displayed in the navigation interface 320.

To facilitate conversion of user inputs received via the navigation interface 320 into structured queries and/or to convert search queries received in formats other than structured queries via the search interface 315 into structured queries, the structured query conversion system 355 includes a query parser, which may be associated with or may be a part of a search system within the virtual computing system (e.g., the virtual computing system 100). The query parser converts the user input (received via the navigation interface 320 or the search interface 315) into a structured query by breaking or tokenizing the user input and particularly, the characters of the user input, into one or more tokens. For each token, the query parser identifies keywords, expressions, and/or IP addresses that are recognized by the search system and/or the navigation and search system 300. The query parser may communicate with various databases (e.g., a keyword database, an expression database, an IP address database, etc.) to parse the user input. The query parser may also convert any “human-friendly” terms in the user input into recognized keywords. The query parser may also rank the identified keywords, identify relationships between the keywords, match keywords and assign scores, etc. to facilitate conversion of the user input into the structured query. The structured query identifies one or more entities and possibly one or more attributes associated with those entities.

Further, the query parser is configured to also recognize filters in the user inputs received via the navigation interface 320 and convert those filters into structured queries as well, as discussed above. In some embodiments, the query parser may generate a formula from the filters. The formula may be made part of the structured query and displayed within the search interface 315 as discussed herein.

Additional details for parsing the user input and converting the user input into a structured query are explained in U.S. application Ser. No. 15/143,060, filed on Apr. 29, 2016, the entirety of which is incorporated by reference herein.

In addition to converting the user input into the structured query, the structured query conversion system 355 stores the structured queries in a database for later use and associates a page with each structured query. The association of the structured queries to their respective pages may also be stored within a database (e.g., the storage pool 170). By associating each structured query to a particular page, the structured query conversion system 355 upon receiving the structured query as a user input via the search interface 315 (or upon receiving a search query in a non-structured query format that is converted into the structured query), may directly display the associated page in the navigation interface 320 instead of displaying a list of search results. In some embodiments, the structured query conversion system 355 may store a URL of each page that is associated with the structured queries. In other embodiments, the structured query conversion system 355 may store other or additional information that identifies the page corresponding to a particular structured query, as well as provides a location of that page to display in the navigation interface 320. In some embodiments, the association between structured queries and pages may be in the form of a look-up table, such that each structured query in the look-up table maps to a corresponding page. In other embodiments, the association may be in other or additional forms.

The navigation page conversion system 360 may similarly be configured to determine a page that is associated with the user input received via the navigation interface 320. In some embodiments, the navigation page conversion system 360 may also be configured as a look-up table in which each user input received via the navigation interface 320, including any filters included in the user input, are mapped to a corresponding page. In other embodiments, the navigation page conversion system 360 may associate user inputs to pages in other or additional ways.

Thus, the back-end system 310 provides an integrated search and navigation feature in which a user may navigate through various pages either by interacting with user control elements (e.g., the menus 335, the filters 340, etc.) on the navigation interface 320 or by entering search queries on the search interface 315. It is to be understood that although only the navigation manager 350, the structured query conversion system 355, and the navigation page conversion system 360 are shown on the back-end system 310, in other embodiments, other components that are considered necessary or desirable to perform the functions described herein may be included in or associated with the back-end system.

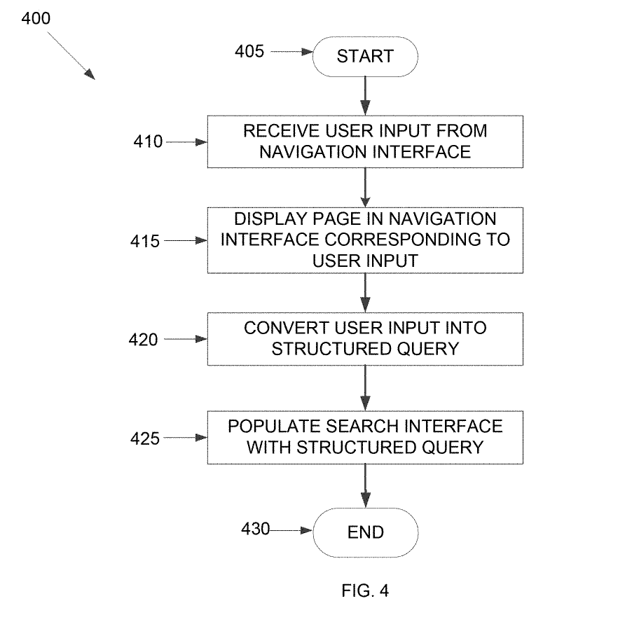

Turning now to FIG. 4, an example flow chart outlining operations of a process 400 for using the navigation and search system 300 in one way is shown, in accordance with some embodiments of the present disclosure. The process 400 may include additional, fewer, or different operations, depending on the particular embodiment. The process 400 is discussed in conjunction with FIG. 3. The process 400 outlines the navigation process when user inputs are received via the navigation interface 320. In other words, the process 400 outlines the navigation process when the user clicks on or otherwise interacts with various user control elements (e.g., the menus 335, the filters 340, etc.) on the navigation interface 320. The process 400 is also used for facilitating a learning process to teach the user how to navigate using a search query via the search interface 315 instead of sending inputs via the navigation interface 320. Thus, the process 400 is used for both, navigating by interacting with the navigation interface 320 and for teaching the user to perform the same navigation using the search interface 315 instead of the navigation interface.

Thus, upon starting at operation 405, the back-end system 310 receives a user input via the navigation interface 320. As noted above, the user may interact with (e.g., click on) a feature (e.g., one of the menus 335) on the navigation interface 320 to send the user input to the back-end system 310. The user may also set one or more filters to assist with the navigation via the navigation interface 320. The navigation manager 350 of the back-end system 310 receives the user input. In some embodiments, the navigation and search system 300 may be configured for an API. In such cases, the API may receive the user inputs and the API (e.g., the API gateway) may send (e.g., via a proxy server) the user input to the navigation manager 350 of the back-end system 310. The user input that the navigation manager 350 receives may identify the feature or user control element that the user interacted with on the navigation interface 320. If the user set any filters, the user input may also include an identification of the filters that the user set. The user input may include any other information that may be considered necessary or desirable for the navigation manager 350 to have.

Upon receiving the user input, the navigation manager 350 communicates with the navigation page conversion system 360, at operation 415, to identify the page that satisfies the user input, including any filters that the user may have set. For example, based upon the user control element that the user interacted with at the operation 410, the navigation page conversion system 360 may identify a page associated with that user control element. Simply as an example without intending to be limiting in any way, if the user clicked on an “entities” menu, the navigation page conversion system 360 may identify a page (including location of that page) that is associated with the “entities” of the virtual computing system (e.g., the virtual computing system 100). In addition, if the user enabled any particular filters at the operation 410, the navigation page conversion system 360 may apply those filters to the entities page such that only data that satisfies those filters is displayed within the entities page. Again, simply as an example and without intending to be limiting in any way, if one of the filters associated with “entities” is alerts and if the user set the alerts filter at the operation 410, the navigation page conversion system 360 may apply the alerts filter to the entities page, such that only alerts related data is displayed on the entities page.

In some embodiments, pages other than or in addition to the entities page may have the alerts related information. In such cases, the navigation page conversion system 360 may combine the alerts related data on the other pages with the data on the entities page (e.g., into a new page or modify the entities page with the combined data) such that data pertaining to alerts from the various entities is displayed in the navigation interface 312. Thus, based upon the information included within the user input, the navigation page conversion system 360 identifies the appropriate content that satisfies the user input. The navigation manager 350 displays that content on the navigation interface 320 at the operation 415. In some embodiments, the navigation manager 350 may display the content in the same window of the navigation interface 320 as the window from which the user input was received. In other embodiments, the navigation manager 350 may display the content in a new window.

Along with identifying the content (e.g., the page) corresponding to the user input, the navigation manager 350 also converts the user input into a structured query using the structured query conversion system 355 at operation 420. As noted above, the structured query conversion system 355 may be associated with or be a part of a search system that is configured to run search queries and return search results in response. The structured query conversion system 355 may include or be associated with a query parser that converts the user input (including any filters therein) into a structured query, as discussed above. In addition to converting the user input into the structured query, the structured query conversion system 355 also stores the structured query into a database for later use and associates a page with the structured query to facilitate navigation using the structured query. Further, at operation 425, the navigation manager 350 populates the search box 325 in the search interface 315 with the structured query determined at the operation 420.

Thus, the user input of the operation 410 results into two operations being performed: displaying of the associated content in the navigation interface 320 at the operation 415 and populating of the associated structured query into the search interface 315 at the operation 425. It is to be understood that although the displaying of the content at the operation 415 is described as happening before the populating of the structured query at the operation 425, the operations 415 and 425 happen simultaneously or substantially simultaneously. In other embodiments, the operation 425 may occur before the operation 415.

By populating the structured query into the search interface 315 at the operation 425, the navigation and search system 300 allows the user to see the search query that the user may instead enter into the search interface 315 to navigate to the same page as that displayed on the navigation interface at the operation 415. The next time the user wishes to navigate to that same page, the user may simply type in the structured query into the search interface 315 and navigate to that page. Thus, the process 400 provides a learnability aspect by which the user may learn to navigate more effectively and quickly. Using the search interface 315 to navigate instead of interacting with the navigation interface 320 to navigate is faster and particularly useful when the page is buried (e.g., nested), or in other words, reachable by clicking through multiple menus and difficult to find. The process 400 ends at operation 430.

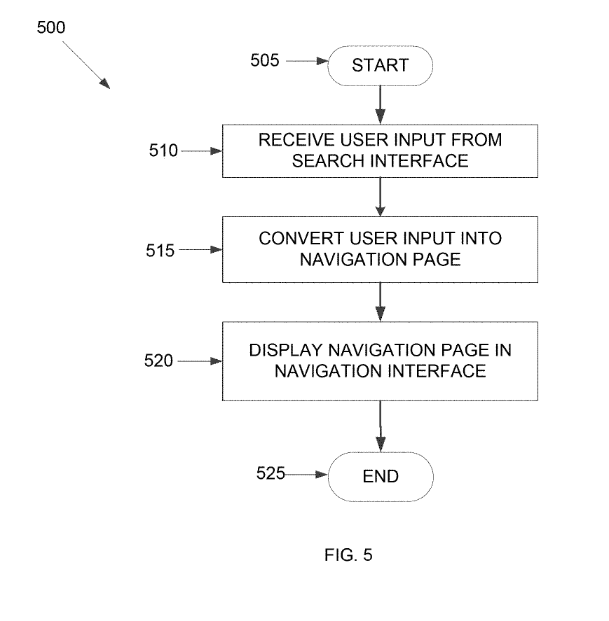

Turning now to FIG. 5, another example flowchart outlining operations of a process 500 are shown, in accordance with some embodiments of the present disclosure. The process 500 is used to navigate to a particular page using the search interface 315. The process 500 may include additional, fewer, or different operations, depending on the particular embodiment. The process 500 is discussed in conjunction with FIG. 3. The process 500 starts at operation 505 with the user desiring to navigate via the search interface 315 entering a search query into the search box 325 of the search interface.

Simply as an example and not intending to be limiting in any way, say the user wishes to navigate to an overall virtual machine page that provides or summarizes information of all virtual machines in the virtual computing system (e.g., the screenshot shown in FIG. 3B). One way to navigate to the overall virtual machine page is via the navigation interface 320 in which the user may interact with (e.g., click on) one or more user control elements (e.g., the menus 335, the filters 340, etc.) to reach the overall virtual machine page. Again, simply as an example and not intending to be limiting in any way, the user may click on an “explore” menu to see a list of various entity types in the virtual computing system, then the user may click on the “VMs” menu to reach the overall virtual machine page. On the overall virtual machine page, if the user wants to view a specific type of information (e.g., alerts being issued by the virtual machines), the user may set one or more filters (e.g., the filters 340) via the navigation interface 320. For example, to see the alerts being issued by the virtual machines, the user may set an alerts filter. The user may also set other filters or further restrict the types of alerts that the user may wish to see. For example, the user may set a severity filter to see alerts that are designated as “critical.” Only after multiple clicks to navigate to the overall virtual machine page and setting the desired filters, the user is able to see the desired information (e.g., the data shown as part of the additional information 345 in FIG. 3B) when the navigation is via the navigation interface 320.

Thus, navigation via the navigation interface 320 takes time and if the user does not know how to navigate to find the desired information, the user is unable to effectively navigate. The other way, and possibly more effective way, to navigate to the same page (e.g., the overall virtual machine page of FIG. 3B) is by using the search interface 315. The user may simply enter a search query into the search box 325 and navigate to the same page that the user may have navigated to via the navigation interface 320. For example, to navigate to the overall virtual machine page, the user may simply enter the keywords (e.g., the structured query) associated with the overall virtual machine page into the search interface 315 and be directed to the overall virtual machine page. For example, if the structured query to access the overall virtual machine page is “VMs,” the user may simply type “VMs” in the search box 325 of the search interface 315. Upon interacting with (e.g., clicking on) the search button 330, the user is directed to the overall virtual machine page. Additionally, the user may enter filters into the search box 325 as well. For example, for setting an alerts filter of severity critical, the user may simply enter keywords associated with “alerts” and “severity critical.” As an example and without intending to be limiting in any way, the user may enter “Alerts Severity=Critical” into the search interface to apply the filters.

Furthermore, the user may apply the filter via the search interface 315 either before or after navigating to the overall virtual machine page. For example, if applied before navigating to the overall virtual machine page, the user may enter “VMs Alerts Severity=Critical” into the search box 325 of the search interface 315. Upon interacting with the search button 330, the user may be directly taken to the overall virtual machine page with the filters applied. In some cases, the user may first navigate to the overall virtual machine page by first entering a search query “VMs” and from the overall virtual machine page, the user may enter another search query of “Alerts Severity=Critical” to apply the filters. In some embodiments, the user may use a combination of navigating via the search interface 315 and via the navigation interface 320 for navigating to desired locations.

Additionally, in some embodiments, the user may enter search queries in a non-structured query format in the search box 325. The structured query conversion system 355, as discussed above, is configured to convert those non-structured query formats into structured query formats and navigate to the proper page.

Accordingly, to search via the search interface 315, the process 500 starts with the user entering a search query in the search box 325 and interacting with (e.g., clicking on) the search button 330 to send the search query. The search query is received by the navigation manager 350 at operation 510. At operation 515, the navigation manager 350 converts the structured query into a corresponding page via the structured query conversion system 355 and/or the navigation page conversion system 360. The navigation manager 350 also converts the structured query associated with the filters and applies those filters to the page to be displayed, which is then displayed at operation 520 in the navigation interface 320. The process 500 ends at operation 525.

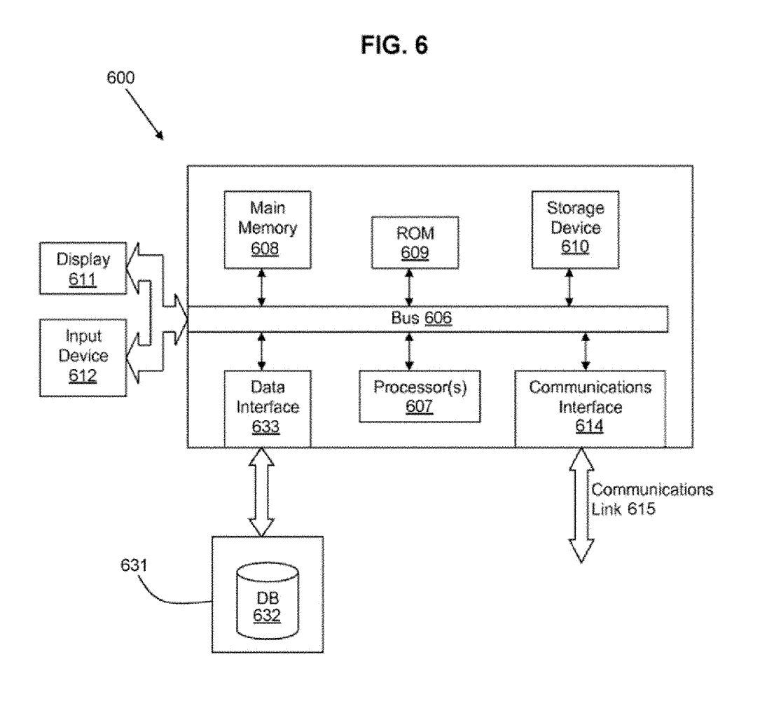

Turning now to FIG. 6, an example computer system 600 is shown, in accordance with some embodiments of the present disclosure. The computer system 600 includes a bus 606 (e.g., an address bus and a data bus) or other communication mechanism for communicating information, which interconnects subsystems and devices, such as processor 607, system memory 608 (e.g., RAM), static storage device 609 (e.g., ROM), disk drive 610 (e.g., magnetic or optical), communication interface 614 (e.g., modem, Ethernet card, a network interface controller (NIC) or network adapter for communicating with an Ethernet or other wire-based network, a wireless NIC (WNIC) or wireless adapter for communicating with a wireless network, such as a WI-FI network), display 611 (e.g., CRT, LCD, LED), input device 612 (e.g., keyboard, keypad, mouse, microphone). In particular embodiments, computer system 600 may include one or more of any such components.

In some embodiments, computer system 600 performs specific operations by processor 607 executing one or more sequences of one or more instructions contained in system memory 608. Such instructions may be read into system memory 608 from another computer readable/usable medium, such as static storage device 609 or disk drive 610. In alternative embodiments, hard-wired circuitry may be used in place of or in combination with software instructions to implement the invention. Thus, embodiments of the invention are not limited to any specific combination of hardware circuitry and/or software. In one embodiment, the term “logic” shall mean any combination of software or hardware that is used to implement all or part of the invention.

The term “computer readable medium” or “computer usable medium” as used herein refers to any medium that participates in providing instructions to processor 607 for execution. Such a medium may take many forms, including but not limited to, nonvolatile media and volatile media. Non-volatile media includes, for example, optical or magnetic disks, such as disk drive 610. Volatile media includes dynamic memory, such as system memory 608.

Common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer can read.

In an embodiment of the invention, execution of the sequences of instructions to practice the invention is performed by a single computer system 600. According to other embodiments of the invention, two or more computer systems 600 coupled by communication link 615 (e.g., LAN, PTSN, or wireless network) may perform the sequence of instructions required to practice the invention in coordination with one another.

Computer system 600 may transmit and receive messages, data, and instructions, including program, i.e., application code, through communication link 615 and communication interface 614. Received program code may be executed by processor 607 as it is received, and/or stored in disk drive 610, or other non-volatile storage for later execution. A database 632 in a storage medium 631 may be used to store data accessible by the computer system 600 by way of data interface 633.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, unless otherwise noted, the use of the words “approximate,” “about,” “around,” “substantially,” etc., mean plus or minus ten percent.

The foregoing description of illustrative embodiments has been presented for purposes of illustration and of description. It is not intended to be exhaustive or limiting with respect to the precise form disclosed, and modifications and variations are possible in light of the above teachings or may be acquired from practice of the disclosed embodiments. It is intended that the scope of the invention be defined by the claims appended hereto and their equivalents.

1. A method comprising:
receiving, by a navigation and search system of a virtual computing system, a user input via a navigation interface of the navigation and search system;
displaying, by the navigation and search system, a page associated with the user input in the navigation interface; and
populating, by the navigation and search system, a search term into a search interface of the navigation and search system,
wherein the search term is determined from the user input and is associated with the page; and
wherein either the user input via the navigation interface or the search term via the search interface is usable to navigate to the page.

2. The method of claim 1, further comprising:
receiving, by the navigation and search system, the search term via the search interface in a subsequent navigation operation;
retrieving, by the navigation and search system, the page associated with the search term; and
displaying, by the navigation and search system, the page in the navigation interface.

3. The method of claim 1, wherein the navigation interface and the search interface are part of a same window.

4. The method of claim 1, wherein the user input comprises one or more filters, and wherein the navigation and search system applies the one or more filters to the page before displaying the page in the navigation interface.

5. The method of claim 4, wherein the navigation and search system parses the one or more filters, and wherein the parsed one or more filters are included in the search term.

6. The method of claim 4, wherein the navigation and search system parses the one or more filters into a formula and includes the formula as part of the search term.

7. (canceled)

8. A system comprising:
a navigation and search system of a virtual computing system, comprising:
a database configured to store one or more pages associated with the navigation and search system; and
a processing unit configured to:
receive a user input via a navigation interface of the navigation and search system;
display a page from the one of the one or more pages in the navigation interface, wherein the page is associated with the user input; and
populate a search term into a search interface of the navigation and search system,
wherein the search term is determined from the user input and is associated with the page; and
wherein either the user input via the navigation interface or the search term via the search interface is usable to navigate to the page.

9. The system of claim 8, wherein the processing unit is further configured to store a structured query obtained from parsing the user input within the database, wherein the structured query is representative of the search term.

10. The system of claim 8, wherein the navigation and search system is installed on a controller/service virtual machine of the virtual computing system.

11. The system of claim 8, wherein the navigation and search system is installed on an overall management system of the virtual computing system.

12. The system of claim 8, wherein the navigation and search system comprises a user interface configured to facilitate interaction with a user, wherein the navigation interface and the search interface are part of the user interface.

13. The system of claim 12, wherein the navigation interface of the user interface comprises one or more menus, and wherein the navigation and search system receives the user input in response to the interaction with the one or more menus.

14. The system of claim 12, wherein the user interface comprises one or more filters that are configured to be enabled or disabled, and wherein the user input comprises the one or more filters that are enabled.

15. The system of claim 12, wherein the navigation and search system receives one or more filters as part of the user input and parses the one or more filters for obtaining a structured query representative of the search term.

16. A non-transitory computer readable media with computer-executable instructions embodied thereon that cause the navigation and search system to perform a process comprising:
receiving a user input via a navigation interface of the navigation and search system;
displaying the page associated with the user input in the navigation interface; and
populating a search term into a search interface of the navigation and search system,
wherein the search term is determined from the user input and is associated with the page; and
wherein either the user input via the navigation interface or the search term via the search interface are usable to navigate to the page.

17. The non-transitory computer readable media of claim 16, wherein the processor is configured to include one or more filters included in the user input in the search term.

18. The non-transitory computer readable media of claim 16, wherein the processor is further configured for:
receiving the search term via the search interface in a subsequent navigation operation;
retrieving the page associated with the search term; and
displaying the page in the navigation interface.

19. The non-transitory computer readable media of claim 16, wherein the navigation interface and the search interface are part of a same window.

20. The non-transitory computer readable media of claim 16, wherein the processor is further configured to store the search term within a database for use in a subsequent navigation operation.

21. The method of claim 1, further comprising parsing, by the navigation and search system, the user input into a structured query, including associating the page with the structured query, wherein the structured query is representative of the search term.
